(19) United States
(12) Patent Application Publication
(10) Pub. No.: US 2015/0250155 A1
(43) Pub. Date: Sep. 10, 2015

(54) FISHING ROD HAVING BENDABLE FRONT THAT CAN BE USED BETWEEN TWO STONES

(71) Applicant: Jae-seon JU, Suncheon-si Jeollanam-do (KR)

(72) Inventor: Jae-seon Ju, Suncheon-si Jeollanam-do (KR)

(21) Appl. No.: 14/433,489

(22) PCT Filed: Oct. 4, 2013
(86) PCT No.: PCT/KR2013/008914

§ 371 Date: Apr. 3, 2015

(30) Foreign Application Priority Data
Oct. 5, 2012 (KR) 10-2012-0110366
Mar. 28, 2013 (KR) 10-2013-0033185

(51) Int. Cl. A01K 87/04; A01K 91/00; A01K 87/02; A01K 87/08

(52) U.S. Cl. CPC A01K 87/04; A01K 87/08; A01K 91/00; A01K 87/025

(57) ABSTRACT

There is provided a fishing rod having a bendable front that can be used between two stones. The fishing rod includes a rotation member at the rear of a first segment, and a rotation groove to which the rotation member is coupled. A support unit includes a rotation pin penetrating the rotation member and the rotation groove. The support unit extends through an extending and retracting hole at the front of a second segment, and the front of the fishing rod in which the first segment is bent at the second segment is bent. By doing this, it is possible to easily catch fish gathering between two stones or in the lower region between two stones in the river or between two stones or in the lower region between two stones of the breakwater of the sea by using the fish hook of the fishing rod having a bendable front that can be used between two stones without using a sinker and a float and requiring high-level fishing skills. Further, when fish is caught, the struggling of the fish is absorbed due to the rotation of a rotation swivel. Accordingly, it is possible to allow anyone to conveniently catch fish with ease and to feel the thrill of catching fish.

### TECHNICAL FIELD

The present invention relates to a fishing rod having a bendable front that can be used between two stones, and more particularly, to a fishing rod having a bendable front that can be used between two stones by which it is possible to easily catch fish gathering between two stones or in the lower region between two stones in the river or between two stones or in the lower region between two stones of the breakwater of the sea by using a fish hook of the fishing rod having a bendable front that can be used between two stones without using a sinker and a float by bending the front of the fishing rod in which a first segment by extending and retracting at a second segment is bent, and it is possible to allow anyone to conveniently catch fish with ease and to feel the thrill of catching fish by absorbing the struggling of the fish due to the rotation of a rotation swivel when fish is caught.

### BACKGROUND ART

As shown in FIG. 1, a typical fishing rod 1 includes a multi-stage segment 2 and a fishing line 3 is fixed to one end of a first segment 2a. The fishing rod includes a fish hook 4 fixed to a lower end of the fishing line 3, a sinker 3a which is positioned at an upper portion of the fish hook 4 and is fixed to the fishing line 3, and a float 3b which is positioned at an upper portion of the sinker 3a and is fixed to the fixing line 3.

The fishing rod 1 described above has the segment 2 whose length is long, and is configured to catch fish in the freshwater, sea or lake. Since the float 3b and the sinker 3a are provided at the fishing line 3 provided at the fishing rod 1, there is a problem that the fishing rod 1 does not catch fish gathering between two stones in the running freshwater (stream or river) or in a lower region between two stones.

Further, since the fishing line is fixed to a rotation swivel rotating at a fixing cap fixed to one end of an expansible and contractible segment and a grip segment, there is a problem that the fishing rod dose not function as a fishing rod that can be used between two stones which is capable of catching fish gathering between two stones in the freshwater or in a lower region between two stones of a breakwater in the sea by using the fishing line provided at the other end of the fishing line.

Furthermore, after the fishing line 3 is fixed by being tied to the first segment 2a of the fishing rod 1, it is difficult to untie the fishing line 3, and there is a problem that the front end of the first segment 2a may be broken when the fishing line 3 is untied from the first segment 2a.

In order to overcome such problems, as shown in FIG. 2, the applicant has filed “fishing rod that can be used between two stones” disclosed in Patent Application No. 10-2012-110366. According to the fishing rod, it is possible to easily catch fish gathering between two stones in the freshwater or sea and in a lower region between two stones. However, when the front of a fishing rod 400 that can be used between two stones is inserted between two stones or in a lower region between two stones, a first segment 200a of an expansible and contractible segment 200 of the fishing rod 400 that can be used between two stones is inserted between two stones or in the lower region between two stones while being not easily bent. For this reason, when the first segment 200a of the expansible and contractible segment 200 of the fishing rod 400 that can be used between two stones is inserted between two stones or in the lower region between two stones, the first segment 200a is caught between two stones or in the lower region between two stones, there is a problem that the first segment 200a may be broken.

### PATENT LITERATURE

PTL 1: Utility Model Registration No. 20-0368101

PTL 2: Utility Model Registration No. 20-0324693

PTL 2: Utility Model Registration No. 20-0292567

### DISCLOSURE

### Technical Problem

In order to solve such problems, an object of the present invention is to provide a new fishing rod having a bendable front that can be used between two stones. The fishing rod includes a rotation member at the rear of a first segment, and a rotation groove to which the rotation member is coupled. A support unit includes a rotation pin penetrating the rotation member and the rotation groove. The support unit extends through an extending and retracting hole at the front of a second segment, and the front of the fishing rod in which the first segment is bent at the second segment is bent. By doing this, it is possible to easily catch fish gathering between two stones or in the lower region between two stones in the river or between two stones or in the lower region between two stones of the breakwater of the sea by using the fish hook of the fishing rod having a bendable front that can be used between two stones without using a sinker and a float and requiring high-level fishing skills. Further, when fish is caught, the struggling of the fish is absorbed due to the rotation of a rotation swivel. Accordingly, it is possible to allow anyone to conveniently catch fish with ease and to feel the thrill of catching fish.

### Technical Solution

In order to achieve such an object, the present invention provides a fishing rod having a bendable front that can be used between two stones, the fishing rod including a grip segment (10) provided with a grip (11), an expansible and contractible segment unit (20) that includes a plurality of segments, is expansible and contractible, and extends and retracts at the front of the grip segment (10), a rotation swivel (30) that is formed at one end of a first segment of the expansible and contractible segment unit (20), and a fishing line (50) including one end fixed to the rotation swivel (30) and the other end fixed to a fish hook (40). In the fishing rod, in the FIGS. 3 and 5, the rotation member (21) is formed at the rear of the first segment (20a) of the expansible and contractible segment unit (20), the rotation groove (22) is formed to allow the rotation member (21) to be inserted, a support unit (24) includes a rotation pin (23) that penetrates the rotation member (21) and the rotation groove (22), the support unit (24) extends through a through hole (20b′) at the front of a second segment (20b) of the expansible and contractible segment unit (20), and the rear of the first segment (20a) of the expansible and contractible segment unit (20) is bent at the front of the second segment (20b) of the expansible and contractible segment unit (20).

Further, a plurality of protrusions (25) may be formed at the inner circumference of the second segment (20b), and engaging members (26) may be formed at the outer circumference of the rear of the support (24) so as to be engaged with the protrusions (25).

Furthermore, a coupling member (27) may be formed at the outer circumference of the support unit (24), and a coupling groove (28) may be formed at the inner circumference of the second segment (20b) such that the coupling groove is coupled to the coupling member (27) rotating when the support unit (24) rotates inside the second segment (20b).

In addition, a separation preventing piece (29) may be formed on one side of the rear of the coupling groove (28) such that the coupling member (27) is not separated from the coupling groove (28) when the coupling member (27) rotates and is coupled to the coupling groove (28).

Moreover, the fishing rod may include a settlement groove (10a) formed at the front circumference of the grip (11) including a rubber band (10b) and a contractible rubber band (11b), the contractible rubber band (11b) settled at the rear of the settlement groove (10a), and a hanging member (11c).

Further, an insertion member (31) formed at the lower side of the rotation swivel (30) may be provided by being inserted into a through hole (33) formed at a fixing cap (32) coupled to one end of the first segment (20a) of the expansible and contractible segment unit (20), the insertion member (31) may include an engagement fixing part (34) that is inserted into the through hole (33) and is integrally formed at the lower end of the insertion member (31) exposed within the through hole (33), and the outer circumference of the insertion member (31) of the rotation swivel (30) rotates at the inner circumference of the through hole (33).

### Effect of the Invention

The present invention includes the rotation member at the rear of the first segment, and the rotation groove to which the rotation member is coupled. The support unit includes the rotation pin penetrating the rotation member and the rotation groove. The support unit extends through the extending and retracting hole at the front of the second segment, and the front of the fishing rod in which the first segment is bent at the second segment is bent. By doing this, it is possible to easily catch fish gathering between two stones or in the lower region between two stones in the river or between two stones or in the lower region between two stones of the breakwater of the sea by using the fish hook of the fishing rod having a bendable front that can be used between two stones without using the sinker and the float and requiring high-level fishing skills.

Further, when fish is caught, the struggling of the fish is absorbed due to the rotation of the rotation swivel. Accordingly, it is possible to allow anyone to conveniently catch fish with ease and to feel the thrill of catching fish.

Moreover, the fixing cap provided with the rotation swivel is provided at the front end of the first segment of the expansible and contractible segment unit, and the fishing line is easily coupled to and is separated from the rotation swivel. Accordingly, it is possible to overcome a difficulty in coupling and separating the fishing line to and from the first segment of the existing fishing rod, and when the front end of the first segment of the existing fishing rod is broken, it is possible to use the fixing cap provided with the rotation swivel of the present invention.

### DESCRIPTION OF DRAWINGS

FIG. 1 is a schematic diagram showing a fishing rod of the related art.

FIG. 2 is a schematic diagram showing a fishing rod of the related art.

FIG. 3 is a schematic diagram according to the present invention.

FIG. 4 is a schematic cross-sectional view showing a rotation swivel according to the present invention.

FIG. 5 is a schematic cross-sectional view showing a first segment and a support unit according to the present invention.

FIGS. 6 to 8 are schematic cross-sectional views showing operations according to the present invention.

FIG. 9 is an example diagram for implementing the present invention.

FIG. 10 is a diagram showing a utilization state according to the present invention.

FIG. 11 is a schematic cross-sectional view showing a state where an insertion member of a rotation swivel according to the present invention is coupled to a through hole.

FIG. 12 is a schematic diagram showing a state where the fishing rod according to the present invention is folded.

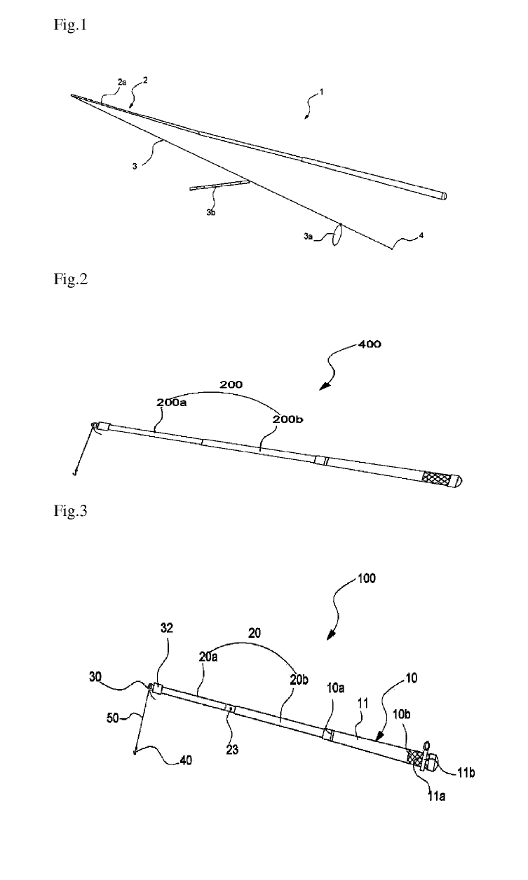

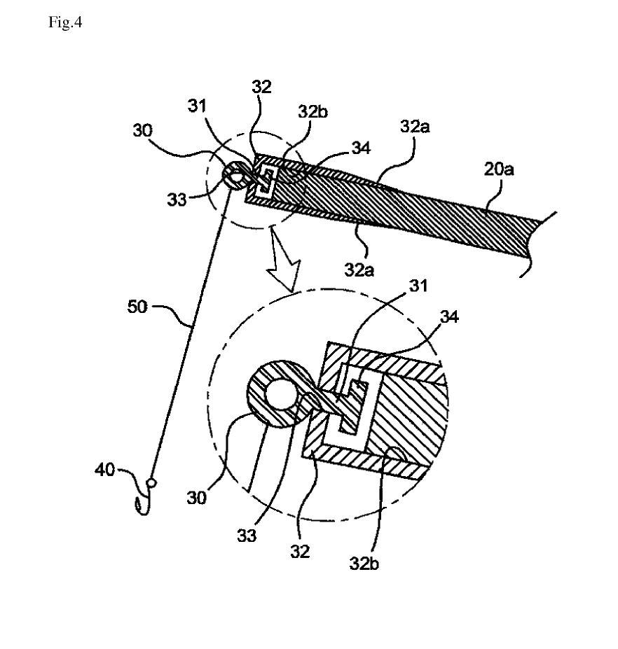

### BEST MODE

Preferred embodiments of the present invention will be described with reference to the accompanying drawings in order to sufficiently understand the present invention.

The embodiments of the present invention can be modified in various forms, and it is apparent that the scope of the present invention is not interpreted as being limited to embodiments described below in detail. The embodiments are provided to more safely describe the present invention to those skilled in the art.

Accordingly, shapes of components in the drawings may be exaggeratedly shown in order to more specifically emphasize the description. It should be noted that in the drawings, the same members are assigned the same reference numerals.

Further, the detailed description of known functions and configurations that may unnecessarily obscure the gist of the present invention will be omitted.

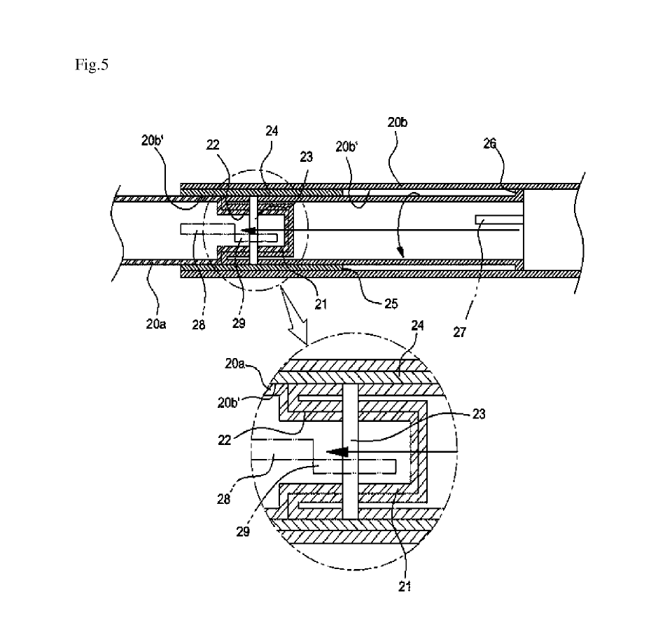

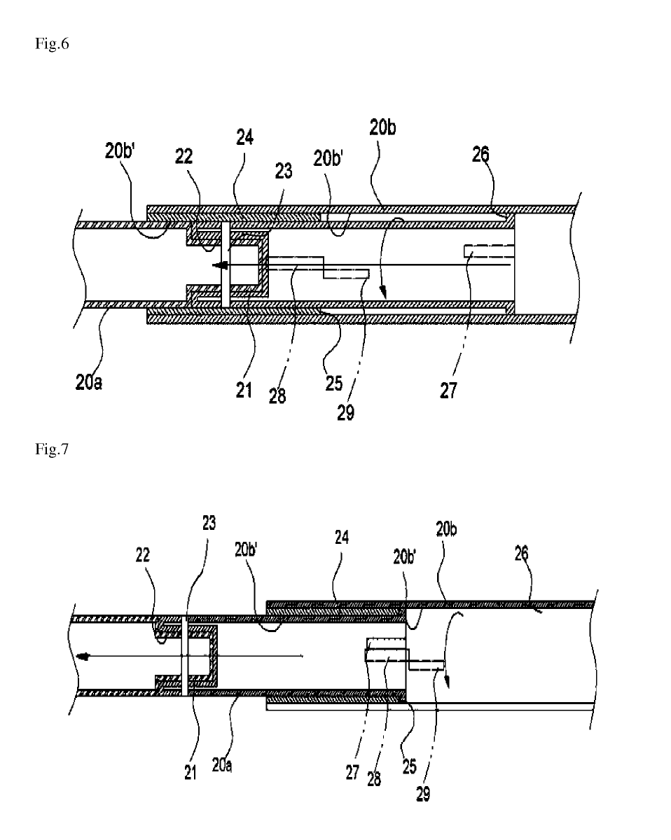

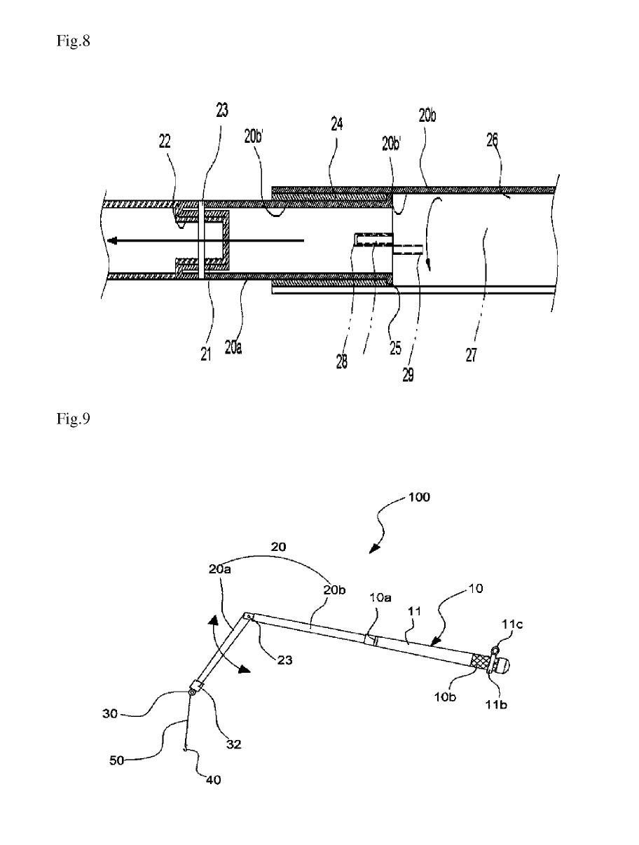

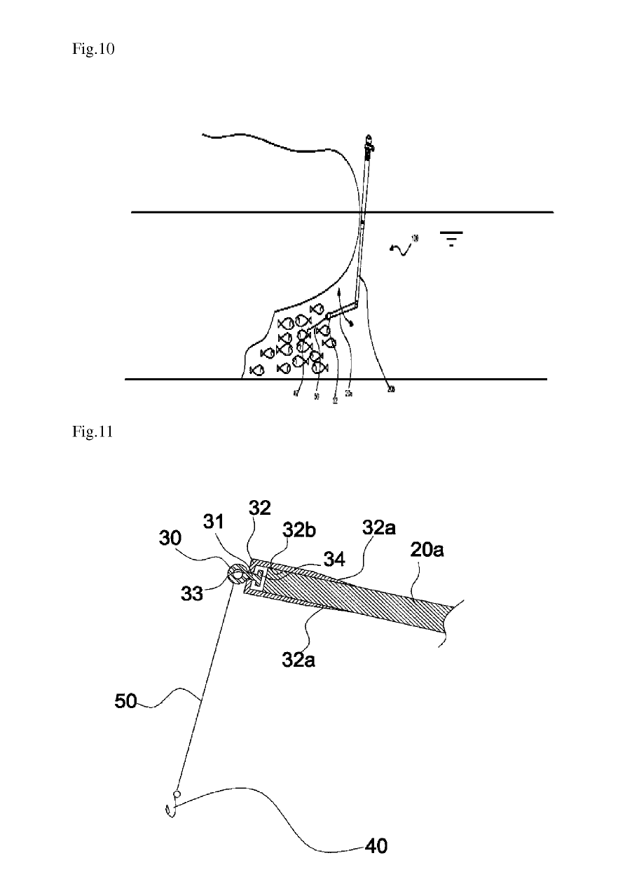

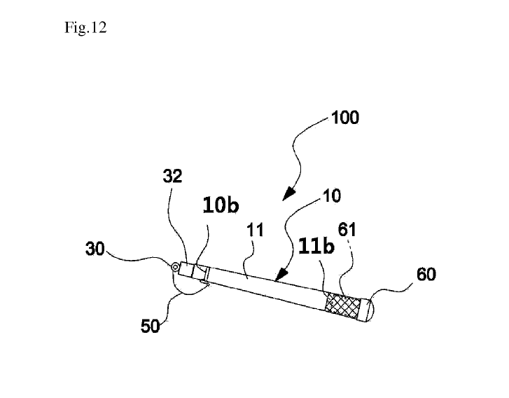

FIG. 3 is a schematic diagram according to the present invention, FIG. 4 is a schematic cross-sectional view showing a rotation swivel according to the present invention, FIG. 5 is a schematic cross-sectional view showing a first segment and a support unit according to the present invention, FIGS. 6 to 8 are schematic cross-sectional views showing operations according to the present invention, FIG. 9 is an example diagram for implementing the present invention, and FIG. 10 is a diagram showing a utilization state according to the present invention.

A fishing rod having a bendable front that can be used between two stones according to the present invention will be described in detail with reference to FIGS. 3 to 10.

The fishing rod that can be used between two stones which is primarily used in freshwater such as a mountain stream or a river includes a grip segment 10 provided with a grip 11, and an expansible and contractible segment unit 20 that includes a plurality of segments, is expansible and contractible, and extends and retracts at the front of the grip segment 10.

The expansible and contractible segment unit 20 includes a plurality of segments, and is expansible and contractible.

The expansible and contractible segment unit 20 described above is variable in length by extending and retracting at the front of the grip segment 10.

*Further, the expansible and contractible segment unit 20 preferably includes two-stage segments.

That is, the expansible and contractible segment unit includes a first segment 20a, and a second segment 20b. An external side of the first segment 20a extends and retracts within the second segment 20b, and the external side of the first segment 20a extends and retracts within the grip segment 10.

As described above, since the grip segment 10 and the expansible and contractible segment unit 20 are configured in two stages, the fishing rod can have an optimum length so as to easily catch fish gathering between two stones in the running freshwater and in a lower region between two stones. Further, when a user catches fish gathering between two stones and in the lower region between two stones by using the fishing rod using a fishing line 50 having a length of 5 cm, the user can feel a big thrill of catching fish.

Furthermore, the fishing rod includes a rotation swivel 30 formed at a first end of the expansible and contractible segment unit 20.

The fishing rod includes a fishing line 50 of which one end is fixed to the rotation swivel 30 and the other end is fixed to a fish hook 40.

Moreover, the length of the fishing line 50 may be 4 cm to 6 cm, and the length of the fishing line 50 is preferably 5 cm.

Meanwhile, since the length of the fishing line 50 is 4 cm to 6 cm, when the fishing rod of the present invention and the fishing line 50 are inserted in the lower region between two stones in the mountain stream or river or between two stones, it is possible to provide the fishing rod and the fish hook capable of optimally catch fish gathering between two stones or in the lower region between two stones.

The fishing rod that can be used between two stones includes a rotation member 21 formed at the rear of the first segment 20a of the expansible and contractible segment 20.

The rotation groove 22 is formed to allow the rotation member 21 to be inserted, and the support unit 24 includes a rotation pin 23 that penetrates the rotation member 21 and the rotation groove 22. The support unit 24 extends and retracts through an extending and retracting hole 20b′ at the front of the second segment 20b of the expansible and contractible segment unit 20.

The rear of the first segment 20a of the expansible and contractible segment unit 20 is bent at the front of the second segment 20b of the expansible and contractible segment unit 20.

As stated above, since the first segment 20a is bent at the second segment 20b, it is possible to easily insert the rotation swivel 30, the fishing line 50 and fish hook 40 between two stones in the freshwater such as the river, or the sea or the lower region between two stones, and thus, it is possible to easily catch fish gathering between two stones or in the lower region between two stones.

That is, a fisherman can conveniently insert the first segment 20a, the rotation swivel 30 provided with the first segment 20a, the fish hook 40 and fishing line 50 of the fishing rod 100 having a bendable front that can be used between two stones between two stones or in the lower region between two stones without bending his or her body or moving from side to side in a standing position, and thus, it is possible to easily catch fish gathering between two stones or in the lower region between two stones by using the fish hook 40.

In addition, a plurality of protrusions 25 is formed at the inner circumference of the second segment 20b.

Engaging members 26 are formed at the outer circumference of the rear of the support unit 24 so as to be engaged with the protrusions 25.

*In this manner, since the engaging members 26 are formed at the rear of the protrusions 25, the rear of the first segment 20a having the support unit 24 does not extend toward the front of the second segment 20b.

Further, a coupling member 27 is formed at the outer circumference of the support unit 24.

A coupling groove 28 is formed at the inner circumference of the second segment 20b so as to be coupled to the coupling member 27 rotating when the support unit 24 rotates inside the second segment 20b.

A separation preventing piece 29 is formed on one side of the rear of the coupling groove 28 such that the coupling member 27 is not separated within the coupling groove 28 when the coupling member 27 rotates and is coupled within the coupling groove 28.

As described above, since the coupling member 27 rotates together with the support unit 24 and is easily inserted within the coupling groove 28, the outer circumference of the rear of the first segment 20a provided with the support unit 24 can be fixed to the inner circumference of the second segment 20b having the coupling groove 28.

Moreover, since the separation preventing piece 29 is formed on one side of the rear of the coupling groove 28, the coupling member 27 is not separated from the coupling groove 28 when the coupling member 27 rotates together with the support unit 24, and thus, the coupling member 27 can be stably coupled to and separated from the coupling groove 28.

Meanwhile, the fishing rod includes a settlement groove 10a formed at a circumference of the front of the grip 11 including a rubber band 10b and a contractible rubber band 11b, the contractible rubber band 11b settled in the settlement groove 10a, and a hanging member 11c.

The band type hanging member 11c is made of flexible synthetic resin, and is easily settled to the grip 11 having the settlement groove 10a.

In addition, since a chemical light emitting light in the night is fitted to the contractible rubber band 11b, it is possible to check where the fishing rod is even in the night, and thus, it is possible to safely catch fish by preventing a negligent accident.

The contractible rubber band 11b and the band type hanging member 11c are provided to easily store the fishing rod that can be used between two stones of the present invention by being hung to a hanging pole (not shown).

Meanwhile, an insertion member 31 formed in the lower side of the rotation swivel 30 is inserted into a through hole 33 formed in a fixing cap 32 whose lower end is coupled to one end of the first segment 20a of the expansible and contractible segment unit 20.

In other words, an insertion part 32b of the fixing cap 32 is coupled by being inserted into the outer circumference of the front end of the first segment 20a, and the insertion member 31 of the rotation swivel 30 is inserted into the through hole 33 formed in the fixing cap 32.

Moreover, the insertion member 31 includes an engagement fixing part 34 that is inserted into the through hole 33 and is integrally formed at a lower end of the insertion member 31 exposed within the through hole 33.

The outer circumference of the insertion member 31 of the rotation swivel 30 rotates at the outer circumference of the through hole 33.

In this manner, since the rotation swivel 30 rotates at the fixing cap 32, when fish is caught between two stones in the running freshwater such as the mountain stream or river or in the lower region between two stones, the struggling of the fish is absorbed due to the rotation of the rotation swivel 30. Further, the rotation swivel can move with water flow between two stones in fast-running freshwater, and thus, it is possible to more conveniently catch fish.

The fishing line 50 includes one end fixed to the rotation swivel 30 and the other end fixed to the fish hook 40.

By doing this, the rotation swivel 30 is provided at the fixing cap 32, and thus, the fishing line 50 is easily tied to or untied from the rotation swivel 30. Furthermore, when the front end of the first segment of the existing fishing rod is broken, it is possible to use the fixing cap 32.

The operations according to the present invention are as follows.

Since the engaging members 26 formed at the rear of the support unit 24 coupled to the rotation member 21 (FIG. 5) formed at the rear of the first segment 20a is engaged, the first segment 20a does not extend forward from the second segment 20a.

Firstly, the first segment 20a extends forward from the second segment 20a such that the engaging members 26 are not engaged with the protrusions 25, the coupling member 27 provided with the support 23 is coupled to the coupling groove 28 formed at the second segment 20b by rotating the first segment 20a toward the one side.

In this case, the coupling member 27 does not rotate by the separation preventing piece 29 provided with the coupling groove 28.

The first segment 20a extends forward again such that the engaging members 26 are engaged with the protrusions 25.

Thereafter, the first segment 20a is bent by rotating downward.

In this case, the rotation member 21 rotates at the rotation groove 22 by using the rotation pin 23.

The bent first segment 20a is inserted between two stones in the freshwater such as the river and the sea or in the lower region between two stones, and thus, it is possible to catch fish gathering between two stones or in the lower region between two stones.

The operation of restoring the bent state of the first segment 20a to a horizontal state and the operation of inserting the first segment 20a into the second segment 20b are performed by reversely performing the aforementioned operations.

Accordingly, the present invention described above includes the rotation member 21 at the rear of the first segment 20a, and the rotation groove 22 to which the rotation member 21 is coupled. The support unit 24 includes the rotation pin 23 penetrating the rotation member 21 and the rotation groove 22. The support unit 24 extends through the extending and retracting hole 20b′ at the front of the second segment 20b, and the front of the fishing rod in which the first segment 20a is bent at the second segment 20b is bent. By doing this, it is possible to easily catch fish gathering between two stones or in the lower region between two stones in the river or between two stones or in the lower region between two stones of the breakwater of the sea by using the fish hook of the fishing rod having a bendable front that can be used between two stones without using the sinker and the float and requiring high-level fishing skills.

In addition, the length of the fishing line 50 may be 4 cm to 6 cm, and the length of the fishing line 50 is preferably 5 cm.

Meanwhile, since the fishing line 50 has the length of 4 cm to 6 cm, the fishing line 50 and the fishing rod of the present invention are inserted between two stones or in the lower region between two stones in the mountain steam or the river, and thus, the fishing rod and the fish hook can have an optimum length so as to easily catch fish gathering between two stones and in the lower region between two stones.

Accordingly, the present invention described above, the first segment 20a, the second segment 20a, the fishing line 50 and the fish hook 40 are primarily inserted between two stones or in the lower region between two stones in the mountain stream or the river, and thus, it is possible to easily catch fish gathering between two stones or in the lower region between two stones by using the fish hook 40 of the fishing rod 100 that does not include the sinker and the float. When fish is caught, the struggling of the fish is absorbed due to the rotation of the rotation swivel 30. Accordingly, it is possible to allow anyone to conveniently catch fish with ease and to feel the thrill of catching fish.

The embodiment of the present invention described above is merely an example, and it is apparent to those skilled in the art that various modifications and equivalents to the embodiment are possible. Therefore, it should be understood that the present invention is not limited to the form mentioned in the detailed description.

Accordingly, the technical scope of the present invention should be defined by the technical ideals of the appended claims. Further, it should be understood that the present invention includes all modifications, equivalents and substitutions within the spirit and range of the present invention.

[Description of Reference Numerals of Drawings]

| | |
|---|---|
| 10: Grip segment | 10a: Settlement groove |
| 10b: Rubber band | 11: Grip |

| | |
|---|---|
| 11b: Contractible rubber band | 11c: Band type hanging member |

| | |
|---|---|
| 20: Expansible and contractible segment unit | 20a: First segment |

| | |
|---|---|
| 20b: Second segment | 20b′: Through hole |
| 21: Rotation member | 22: Rotation groove |

| | |
|---|---|
| 23: Rotation pin | 24: Support unit |
| 25: Protrusion | 26: Engaging member |

| | |
|---|---|
| 27: Coupling member | 28: Coupling groove |

| | |
|---|---|
| 29: Separation preventing piece | 30: Rotation swivel |

| | |
|---|---|
| 31: Insertion member | 32: Fixing cap |

32a: Inclined part
32b: Insertion part

| | |
|---|---|
| 33: Through hole | 34: Fixation engaging part |
| 40: Fish hook | 50: Fishing line |

61: rear insertion member
100: Fishing rod having bendable front that can be used between two
stones

1. A fishing rod having a bendable front that can be used between two stones, the fishing rod including a grip segment (10) provided with a grip (11), an expansible and contractible segment unit (20) that includes a plurality of segments, is expansible and contractible, and extends and retracts at the front of the grip segment (10), a rotation swivel (30) that is formed at one end of a first segment of the expansible and contractible segment unit (20), and a fishing line (50) including one end fixed to the rotation swivel (30) and the other end fixed to a fish hook (40),
wherein the rotation member (21) is formed at the rear of the first segment (20a) of the expansible and contractible segment unit (20),
the rotation groove (22) is formed to allow the rotation member (21) to be inserted,
a support unit (24) includes a rotation pin (23) that penetrates the rotation member (21) and the rotation groove (22),
the support unit (24) extends through a through hole (20b′) at the front of a second segment (20b) of the expansible and contractible segment unit (20), and the rear of the first segment (20a) of the expansible and contractible segment unit (20) is bent at the front of the second segment (20b) of the expansible and contractible segment unit (20).

2. The fishing rod according to claim 1,
wherein a plurality of protrusions (25) is formed at the inner circumference of the second segment (20b), and
engaging members (26) are formed at the outer circumference of the rear of the support (24) so as to be engaged with the protrusions (25).

3. The fishing rod according to claim 1,
wherein a coupling member (27) is formed at the outer circumference of the support unit (24), and
a coupling groove (28) is formed at the inner circumference of the second segment (20b) such that the coupling groove is coupled to the coupling member (27) rotating when the support unit (24) rotates inside the second segment (20b).

4. The fishing rod according to claim 3,
wherein a separation preventing piece (29) is formed on one side of the rear of the coupling groove (28) such that the coupling member (27) is not separated from the coupling groove (28) when the coupling member (27) rotates and is coupled to the coupling groove (28).

5. The fishing rod according to claim 1,
wherein an insertion member (31) formed at the lower side of the rotation swivel (30) is provided by being inserted into a through hole (33) formed at a fixing cap (32) coupled to one end of the first segment (20a) of the expansible and contractible segment unit (20),
the insertion member (31) includes an engagement fixing part (34) that is inserted into the through hole (33) and is integrally formed at the lower end of the insertion member (31) exposed within the through hole (33), and
the outer circumference of the insertion member (31) of the rotation swivel (30) rotates at the inner circumference of the through hole (33).

6. A fishing rod having a bendable front that can be used between two stones, the fishing rod including a rotation swivel (30) that is formed at one end of a first segment of an expansible and contractible segment unit (20); and a fishing line (50) including one end fixed to the rotation swivel (30) and the other end fixed to a fish hook (40), an insertion member (31) formed at the lower side of the rotation swivel (30) being provided by being inserted into a through hole (33) formed at a fixing cap (32) coupled to one end of the first segment (20a) of the expansible and contractible segment unit (20), the insertion member (31) including an engagement fixing part (34) that is inserted into the through hole (33) and is integrally formed at the lower end of the insertion member (31) exposed within the through hole (33), the outer circumference of the insertion member (31) of the rotation swivel (30) rotating at the inner circumference of the through hole (33), an insertion part (32b) being formed within the fixing cap (32), and an inclined part (32a) being formed at the lower circumference, the fishing rod comprising:
a grip segment (10) provided with a grip (11); and
a two-stage expansible and contractible segment unit (20) that includes a plurality of segments, is expansible and contractible, and extends and retracts at the front of the grip segment (10),
wherein the grip (11) includes a rubber band (10b) and a contractible rubber band (11b),
the fish hook is fixed to the rubber band (10a),
the grip segment (10) includes a cap (60) having a rear insertion member (61) inserted into the rear, and
the length of the fishing line (50) is 4 cm to 6 cm.
